(19) United States
(12) Patent Application Publication
(10) Pub. No.: US 2005/0232257 A1
(43) Pub. Date: Oct. 20, 2005

(54) Integrated interface for a communication system

(76) Inventors: Ronald J. Daley, Ellington, CT (US); Gregory A. Portanova, Somers, CT (US)

Correspondence Address: CARLSON, GASKEY & OLDS, P.C., 400 WEST MAPLE ROAD, SUITE 350, BIRMINGHAM, MI, 48009, US

(21) Appl. No.: 10/824,819

(22) Filed: Apr. 15, 2004

(51) Int. Cl. H04L 12/40

(52) U.S. Cl. 370/362; 370/402

(57) ABSTRACT

An integrated interface integrates a bus repeater and remote terminal into a single interface linking a main bus and an extended bus in a communication system. In one embodiment, the remote terminal communicates directly with the bus repeater to monitor bus repeater operation. By integrating the bus repeater and remote terminal together, the integrated interface can use only one set of input and output components for both the bus repeater and remote terminal, reducing the total number of components in the communication system.

### TECHNICAL FIELD

The present invention is related to communication systems, and more particularly to an architecture for a communication system.

### BACKGROUND OF THE INVENTION

Communication systems are used in many applications, including aircraft weapon control and status monitoring. The applications may include a main data bus that is directly connected to a central computer and an extended bus that carries data from the central computer to remote terminals 10 connected to the extended bus through a single electrical interface. In an aircraft weapons system, for example, the remote terminals may be associated with stores (e.g., weapons) carried on the aircraft.

To ensure that the signals from the central computer reach the remote terminals, the signals are often sent to an electronic package that acts as a “black box” that retransmits the data received from the central computer to the extended bus remote terminals. The electronic package may also conduct additional computations, data changes, or other signal processing steps before sending the signals to the remote terminals.

FIG. 3 illustrates one example of a prior art system that conforms with currently-used standard design requirements (e.g., Mil-Std-1553). Data traveling from a main bus 12 to an extended bus 14 travels through an electronic package 16 containing a bus repeater 18 connecting the two buses 12, 14. To link the bus repeater 18 to the two buses 12, 14, the bus repeater 18 uses two transceivers 20, 22, with one transceiver 20 connected to the main bus 12 via a first isolation transformer 24 and the other transceiver 22 connected to the extended bus 14 via a second isolation transformer 26. Depending on the distance between each transceiver and its corresponding bus connection, a coupling transformer 28 may be also be included between each isolation transformer 24, 26 and its corresponding bus 12, 14. The bus repeater 18 sends signal traffic between the buses 12, 14 without acting on the signals themselves.

Further, the electronic package 16 itself may need to monitor and control its own functions based on the data sent to the extended bus 14. Thus, remote terminal interface control logic 30 may be included in the electronic package 16 and have its own associated transceiver 32 that is connected to its own corresponding isolation transformer 34, which is in turn connected to a coupling transformer 28 that couples the isolation transformer 34 to the extended bus 14. This additional remote terminal interface 30 receives and responds to messages from the extended bus 14 after converting the analog signals to a digital format. A subsystem 36 looks at the data in the signal traveling through the electronic package 16 and processes it from an input/output perspective. The received data may result in a decision to release a weapon from the aircraft in which the remote terminal 10 is located.

The separate bus repeater 18 and remote terminal interface 30 form a configuration that provides reliable communication between two buses that increase the number of circuit elements in the electronic package 16, thereby increasing product costs and circuit board area.

There is a desire for a simpler, lower cost communication system that provides more direct communication between the main bus and extended bus through a single electrical interface.

### SUMMARY OF THE INVENTION

The present invention is directed to an integrated interface that links a main bus and an extended bus in a communication system. The integrated interface includes a bus repeater and remote terminal integrated into a single device. In one embodiment, the remote terminal interface in the electronic package communicates directly with the bus repeater to respond to central computer commands and monitors and controls bus repeater operation.

By integrating the bus repeater and remote terminal together, the integrated interface can use only one set of input and output components, such as transceivers and coupling transformers, for both the bus repeater and remote terminal rather than providing separate components for the remote terminal alone. As a result, the remote terminal can tap directly into data going through the bus repeater rather than obtaining and converting data on its own. The integrated interface reduces the total number of components within the communication system.

### BRIEF DESCRIPTION OF THE DRAWINGS

FIG. 1 is a representative diagram of a system incorporating an electronic package according to one embodiment of the invention;

FIG. 2 is a representative diagram of the electronic package of FIG. 1 in more detail; and

FIG. 3 is a representative diagram of a prior art system configuration.

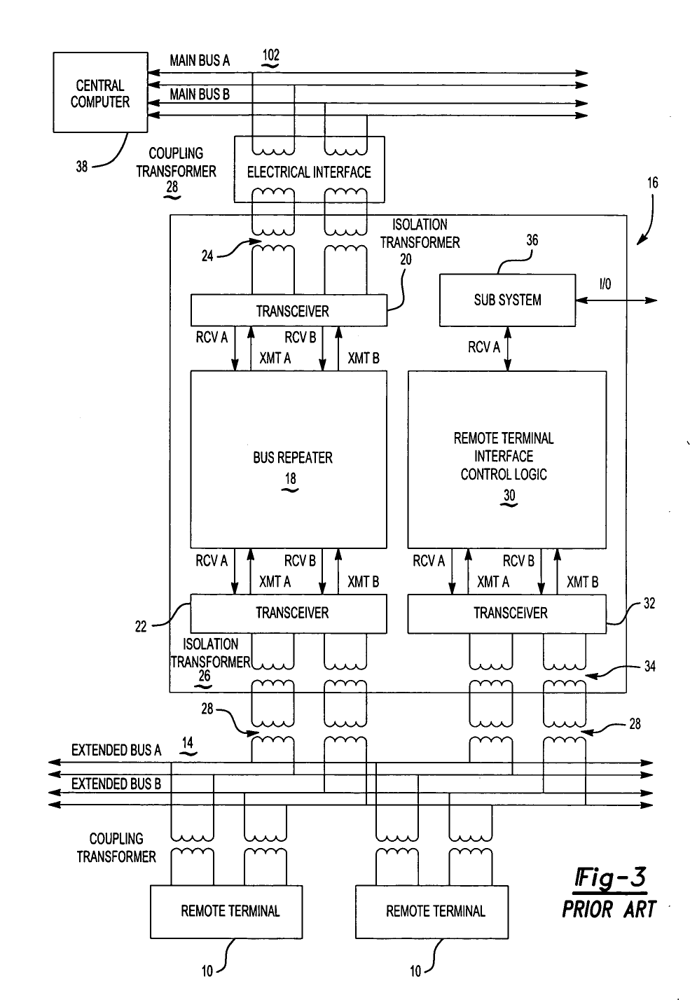

### DETAILED DESCRIPTION OF THE EMBODIMENTS

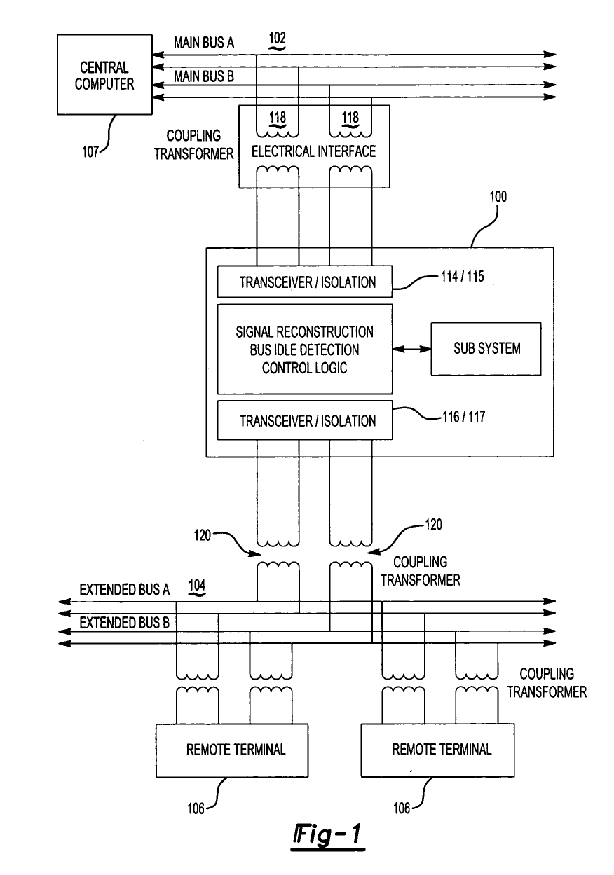

FIG. 1 is a representative general diagram of a communication system incorporating an electronic package 100 according to one embodiment of the invention. The examples described below focus on using the communication device in an aircraft weapons system, the electronic package 100 can be used in any desired application. In the illustrated example, the electronic package 100 acts as a pass-through between a main data bus 102 and an extended data bus 104 having multiple remote device terminals 106 associated with external devices (e.g., weapons) to be controlled. The main data bus 102 may be a primary bus that carries data to subsystems, including the electronic package 100, throughout a main system (e.g., an aircraft) to and from is a central computer 107 to communicate with the subsystems, while the extended data bus 104 carries data from the electronic package 100 to the remote device terminals 106.

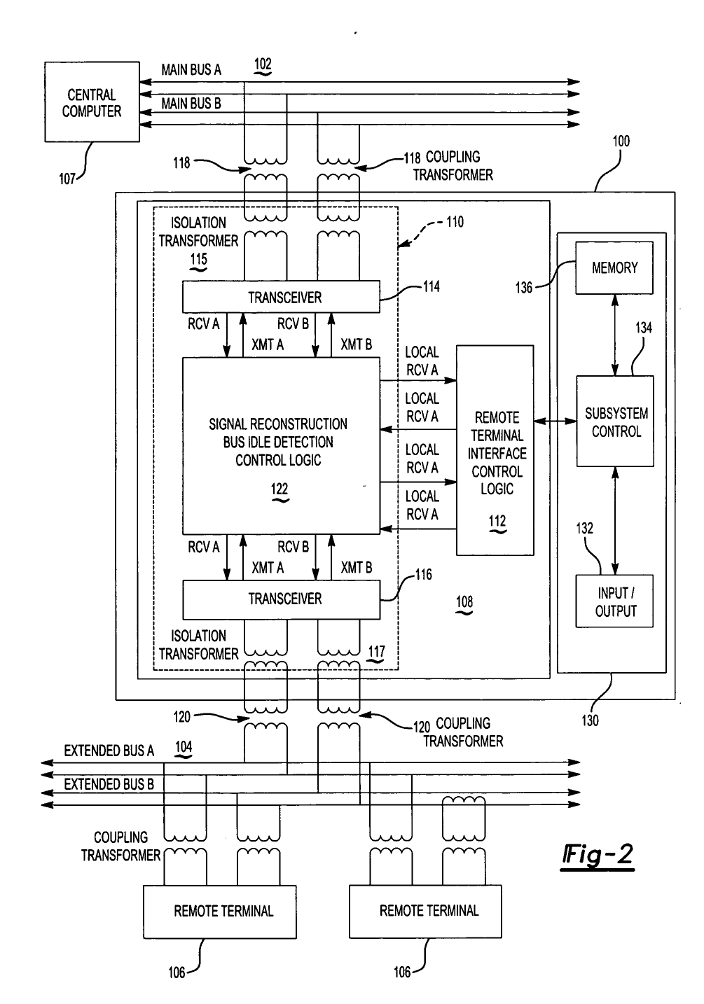

The electronic package 100 provides a virtually interface for data flow from the central computer 107 to more remote areas, such as the remote device terminals 106. Rather than providing a bus repeater and a remote terminal that are separate and independent within the package and providing each with its own transceiver and coupling transformer like currently-known systems complying with design standards (e.g., Mil-Std-1553), the inventive system combines a bus repeater and remote terminal into a single integrated interface 108. This integrated interface 108 allows the functions of both a bus repeater 110 and a remote terminal 112 (FIG. 2) to be carried out using only two transceivers/isolation transformers 114/115, 116/117 and two associated coupling transformers 118, 120, one transceiver 114 and coupling transformer 118 on the main bus 102 side and one transceiver 116 and coupling transformer 120 on the extended bus side of the bus repeater 110. As shown in FIG. 2, the isolation transformers 115, 117 are part of the electronic package 100 while the coupling transformers 118, 120 act as bus connections. This structure therefore eliminates the need to provide a separate transceiver, isolation transformer and coupling transformer specifically for the remote terminal 112 alone.

Signals from the central computer 107 can therefore travel between the main bus 102, the extended bus 104, and the remote terminals 106 via the bus repeater portion 110 through the integrated interface 108. At the same time, the remote terminal portion 112 of the integrated interface 108 can tap data from the bus repeater 110 portion for operation of the electronic device 100.

In one embodiment, the analog data from the buses 102, 104 are converted into digital data by the bus repeater portion 110 by analog-to-digital conversion circuitry in the transceivers 114, 116. The remote terminal portion 112 can then simply tap off the digital data from the bus repeater portion 110 directly rather than having to conduct its own separate conversion of analog data obtained from either bus 102, 104. Similarly, digital data from the remote terminal 112 and the bus repeater 110 can both be converted by digital-to-analog conversion circuitry in the transceivers 114, 116. By combining the bus repeater 110 and the remote terminal 112 functions into a single integrated interface 108, the remote terminal 112 in the interface can simply transmit and receive already-converted digital data to and from the bus repeater 110 without conducting its own analog-to-digital conversion.

FIG. 2 illustrates the electronic package 100 in greater detail. As noted above, the electronic package 100 includes an integrated interface 108 that includes a bus repeater portion 110 and a remote terminal portion 112. As shown in FIG. 2, the bus repeater 110 and remote terminal 112 send digital signals to and from each other directly, allowing the remote terminal 112 to monitor the bus repeater 110 communication traffic operation in real time if desired. Because the signals going through the bus repeater 110 are already converted into digital data, the remote terminal 112 can tap directly into the bus repeater 110 to obtain the digital data without having to obtain and convert data from the extended bus 104 on its own. Thus, the remote terminal 112 in the electronic package 100 can rely on the bus repeater 110 to supply it with data and does not need its own transceiver or isolation/coupling transformers, reducing the total number of parts in the electronic package 100. This single chip solution will require fewer components in the system, reduce power consumption, reduce data delay and data latency and also improves overall system reliability.

In one embodiment, the electronic package 100 includes a programmable-type part device, such as a field-gate programmable array (FPGA), that can be programmed with code in a high-level language. This code can then be easily transferable to other devices. Making the electronic package 100 programmable eliminates part obsolescence, further improving system functionality.

As shown in FIG. 2, the transceivers 114, 116 may form part of the bus repeater 110. The bus repeater 110 also includes signal filtering and reconstruction control logic 122 that reconstructs data received by the bus repeater 110 in real time and controls the transmit/receive direction of data going through the bus repeater 110. Signal filtering may include data validation, synchronization, and data bit extraction. Data reconstruction involves resynchronization and data bit insertion of data passing from the main bus 102 to the extended bus 104. The control logic controls the transmit/receive direction by controlling the operating modes of the first and second transceivers 114, 116. For example, the first transceiver 114 is in a receive mode and the second transceiver 116 is in a transmit mode when the system is first powered up and after any message transfer is complete to make them ready to carry a message from the central computer 107 to the remote terminal 106 (i.e., a transmit cycle). After receiving a valid command from the central computer 107, the control logic 122 places the second transceiver 116 into a receive mode and the first transceiver 114 into a transmit mode to carry an acknowledgement from the remote terminal 106 (i.e., a receive cycle).

The bus repeater 110 includes a bus idle detection circuit that determines bus activity as well as provides a fail-safe direction mechanism in case the remote terminal 106 fails to acknowledge receipt of the transmitted signal from the central computer 107 to the bus repeater 110. More particularly, if the remote terminal 106 fails to respond within a predetermined amount of time, the control logic 122 reinitializes the transceivers 114, 116 to be ready for the next transmission from the central computer 107 by placing the first transceiver 114 back in the receive mode and the second transceiver 116 in the transmit mode.

A subsystem 130 in the electronic package 100 may be used to process the data send through the bus repeater 110 from an input/output perspective and to control the device in which the remote terminal 106 resides. In one embodiment, the subsystem 130 an input/output 132, a subsystem controller 134, and a memory 136. The subsystem 130 itself can be any subsystem appropriate for the system in which the electronic package 100 is used.

The specific input and output characteristics of the electronic package 100 can include any characteristics (e.g., input waveform compatibility, common mode rejection, noise rejection, etc.) that ensure compatibility with other components in the communication system. In one embodiment, the architecture of the electronic package 100 supports a command/response system where the central computer 107 always initiates a transmission cycle with the remote terminals 106. If the inventive electronic package 100 is used in, for example, a weapon-carrying aircraft, the remote terminals 106 may be configured to be responsible for controlling weapon stores. In this example, data entities, such as the time of store release, would be required by the remote terminal 106 before releasing the store from the aircraft.

By encompassing the remote terminal in the electronic device within the bus repeater to form a single integrated interface, the invention eliminates the transceiver, isolation transformers and the coupling transformers normally associated with a standard configuration (e.g., a Mil-Std-1553 dual-redundant configuration), reducing the overall number of components in the system. Further, the bus repeater and remote terminal co-exist as a single part in the electronic package, creating a single chip solution for the interface between the main and extended buses. Note that the integrated interface can be in the form of a reprogrammable device that can be programmed with high-level code that is easily transferable to other devices in the system, eliminating part obsolescence.

The inventive structure is therefore able to eliminate the isolation transformers used in previously-known systems, resulting in fewer parts, lowered system cost and improved reliability.

It should be understood that various alternatives to the embodiments of the invention described herein may be employed in practicing the invention. It is intended that the following claims define the scope of the invention and that the method and apparatus within the scope of these claims and their equivalents be covered thereby.

1. An integrated interface for a communication system, comprising:
a bus repeater having a first data interface to couple with a main bus and a second data interface to couple with an extended bus; and
a remote terminal in direct communication with the bus repeater.

2. The integrated interface of claim 1, wherein the first data interface is a first transceiver and the second data interface is a second transceiver.

3. The integrated interface of claim 2, wherein at least one of the first and second transceivers includes analog-to-digital conversion circuitry and includes digital-to-analog conversion circuitry.

4. The integrated interface of claim 1, wherein at least one of the bus repeater and the remote terminal is a programmable device.

5. The integrated interface of claim 1, wherein the bus repeater comprises signal filtering and reconstruction control logic that reconstructs received data and controls a transmit/receive direction of data through the bus repeater.

6. The integrated interface of claim 5, wherein the signal filtering and reconstruction control logic is in a reprogrammable device in the bus repeater.

7. The integrated interface of claim 1, further comprising a bus idle detection circuit in the bus repeater.

8. A communication system, comprising:
a main data bus;
an extended data bus;
an integrated interface that forms a communication link between the main data bus and the extended data bus, the integrated interface comprising
a bus repeater having a first transceiver to couple with the main bus and a second transceiver to couple with the extended bus, and
a remote terminal in direct communication with the bus repeater; and
a central computer in communication with the main data bus.

9. The communication system of claim 8, wherein at least one of the first and second transceivers includes analog-to-digital conversion circuitry and includes digital-to-analog conversion circuitry.

10. The communication system of claim 8, wherein at least one of the bus repeater and the remote terminal is a programmable device.

11. The communication system of claim 8, wherein the bus repeater comprises signal filtering and reconstruction control logic that reconstructs received data and controls a transmit/receive direction of data through the bus repeater.

12. The communication system of claim 11, wherein the signal filtering and reconstruction control logic is in a reprogrammable device in the bus repeater.

13. The communication system of claim 8, further comprising a bus idle detection circuit in the bus repeater.

14. The communication system of claim 8, wherein the system is an aircraft communication system.

15. The communication system of claim 14, further comprising a plurality of remote device terminals in communication with the extended bus, wherein each remote device terminal is associated with an aircraft weapon.
